(19) United States
(12) Patent Application Publication
(10) Pub. No.: US 2012/0123736 A1
(43) Pub. Date: May 17, 2012

(54) SYSTEM FOR RAPID ASSESSMENT OF GRADE VARIATIONS AND METHOD FOR USING A SYSTEM

(76) Inventor: Michael S. Holgate, Asheville, NC (US)

(21) Appl. No.: 12/944,206

(22) Filed: Nov. 11, 2010

(51) Int. Cl. G06F 15/00; G01B 11/24

(52) U.S. Cl. 702/167

(57) ABSTRACT

A system for estimating or calculating grade variations of a ground surface is provided that is convenient to use and provides data of sufficient precision for the estimating or calculating process. The system can be deployed for estimating or calculating grade variations in connection with the placement and installation of fences, gates, pools, drainage, steps, decks, patios, contour features, ponds, driveways, and other site improvements. In addition to a deployment of the system to quickly establish and/or verify elevations of outdoor features, the system can be deployed to quickly establish and/or verify elevations in a building structure for installing cabinets, countertops, or alternating current outlets.

### BACKGROUND OF THE INVENTION

The present invention relates to a system for providing information to assess a profile characteristic of a surface and method for using such a system and, more particularly, relates to a system for estimating or calculating grade variations that is convenient to use and that provides data of sufficient precision for the estimating or calculating process and a method for using such a system.

The expertise needed for proper landscape construction is often not fully appreciated when it comes to developing or improving the ground property of a house or building site. A landscape designer, engineer, technician, or architect generally approaches each project armed with a pencil, a writing pad and a tape measure but there is no standard or frequently used device for estimating or calculating grade variations that is convenient to use and that provides data of sufficient precision for the estimating or calculating process. The lack of such a device is all too evident when an installation is in progress on a house or building site and problems that could have been addressed in a prior planning step are first noticed and corrected (or attempted to be corrected) by field crews. To be sure, it is well known, particularly with respect to the construction of houses and other structures, to deploy laser devices to precisely ascertain horizontal or vertical lines in such structures, such as, for example, lines on ceilings or walls, or level surfaces in rooms. Construction laser devices of this type have lasers arranged in a housing to emit light for producing lines and points. If necessary, the laser beam can be rotationally radiated by means of a prism, for example. Measuring devices such as lasers of this type employed in construction can be secured on a tripod, namely on the tripod head thereof emanating from the tripod legs, which in principle can be pivoted in relation to the tripod head. The three tripod legs typically emanate from the tripod head to facilitate a secure set-up. Independently thereof, the height of the device can be adjusted within a certain range by adjusting the length of the tripod legs and their arrangement in relation to one another. It is commonly known that by securing a laser on a clamping rod arranged between the floor and ceiling of a room, an optical marking can be made at nearly any height in a room. U.S. Pat. No. 6,804,893 discloses a laser leveling system that comprises a height-adjustable clamping rod extending between the floor and ceiling that can be clamped into position and consists of telescoping tubes. A laser measuring device can be adjusted along the clamping rod and fixed in a desired position. The system can also be propped up in a doorframe.

While laser-assisted measuring devices are thus known, and have been extensively integrated into survey equipment that is deployed for landscape construction uses, the use of traditional survey equipment for estimating or calculating grade variations is in the end not practical for the functional-concept plan phase of a landscape construction project. The need for a two person crew—with one person operating the laser device and another person operating a complementary deflector associated with the laser device—imposes a manpower requirement and reduces the convenience of such traditional survey devices. A further drawback with traditional survey equipment such as conventional tripods, floor-to-ceiling poles, and other level mounting combinations and equipment is the complexity involved in interpreting the data generated by such equipment, including the need to perform mathematical calculations to yield results. Also, even automatically operable tripods, floor-to-ceiling poles, and other level mounting combinations/equipment may require two or more operators to manage equipment during setup and use. Thus, the need remains for a device for estimating or calculating grade variations that is convenient to use and that provides data of sufficient precision for the estimating or calculating process. Additionally, it is desirable that such a tool could be used throughout construction of each project as a check-device, suitable for operation by homeowners, designers, and even installation personnel.

### SUMMARY OF THE INVENTION

The present invention provides a system for estimating or calculating grade variations that is convenient to use and that provides data of sufficient precision for the estimating or calculating process and a method for using such a system. The inventive system for estimating or calculating grade variations can be deployed for estimating or calculating grade variations in connection with the placement and installation of fences, gates, pools, drainage, steps, decks, patios, contour features, ponds, driveways, and other site improvements. In addition to a deployment of the system to quickly establish and/or verify elevations of outdoor features, the inventive system for estimating or calculating grade variations can be deployed to quickly establish and/or verify elevations in a building structure for installing cabinets, countertops, alternating current outlets, etc.

One aspect of the present invention comprises a system having a reference component, the reference component having a fulcrum end and a remote end. The fulcrum end and the remote end of the reference component delimit therebetween a longitudinal dimension of the reference component and the fulcrum end is removably positionable on a stand-off site. The system also has a first target pick off device, the first target pick off device being mountable to the reference component at a base reading spot and being operable to emit an incident signal to be incident on an initial target on a surface that is spaced from the stand-off site. The incident signal is detectable such that an operator can determine that an incident signal emitted by the first target pick off device has been incident on the initial target. The system also comprises a follow-on positioner, the follow-on positioner being operable, while the fulcrum end of the reference component is positioned on the stand-off site, to dispose a target pick off device at a follow-on reading spot relative to the reference component that is longitudinally spaced from the base reading spot. The follow-on positioner is operable to dispose at least one of the first target pick off device or another target pick off device at the follow-on reading spot at which the respective target pick off device can emit an incident signal to be incident on at least one of the initial target or a subsequent target on the surface that is spaced from the stand-off site. The system also has a data interplay device, the data interplay device offering longitudinal data relating to the base reading spot and the follow-on reading spot, wherein the system is operable to provide an operator with information relating to at least two longitudinal spaced locations of the reference component for use in assessing a profile characteristic of the surface.

Another aspect of the invention includes the system described above wherein the reference component is a pole. The system described above can also be configured with the first target pickoff device being a laser beam emitting device. Another aspect of the invention comprises the system described above wherein the reference component is a pole and wherein the follow-on positioner is releasably securable at selected positions on the pole. The system can further comprise a level gauge indicating device, the level gauge indicating device being operable to indicate a degree of deviation of the pole from a selected orientation. Another aspect of the invention includes the system described above which further comprises a motion value indicator operable to provide measurement information with respect to a change of distance along an axis perpendicular to the longitudinal dimension of the reference component.

Another embodiment of the invention includes a system for providing information to assess a profile characteristic of a surface. The system comprises a reference component, the reference component having a fulcrum end and a remote end. The fulcrum end and the remote end of the reference component delimit therebetween a longitudinal dimension of the reference component and the fulcrum end is removably positionable on a first stand-off site and a second stand-off site at a spacing from the first stand-off site. The system also includes first target pick off device, the first target pick off device being mountable to the reference component at a base reading spot and is operable. The fulcrum end of the reference component is positioned on the first stand-off site to emit an incident signal to be incident on an initial target on a surface that is laterally spaced from the first stand-off site with the incident signal being detectable such that an operator can determine that an incident signal emitted by the first target pick off device has been incident on the initial target. The system also has a follow-on positioner, the follow-on positioner being operable, while the fulcrum end of the reference component is positioned on the second stand-off site, to dispose a target pick off device at a follow-on reading spot relative to the reference component that is longitudinally spaced from the base reading spot. The follow-on positioned is operable to dispose at least one of the first target pick off device or another target pick off device at the follow-on reading spot at which the respective target pick off device can emit an incident signal to be incident on at least one of the initial target or a subsequent target on the surface that is laterally spaced from both the first stand-off site and the second stand-off site. The system also includes a data interplay device, the data interplay device offering longitudinal data relating to the base reading spot and the follow-on reading spot. The system is operable to provide an operator with information relating to at least two longitudinal spaced locations of the reference component for use in assessing a profile characteristic of the surface.

The system may be clamp-adapted to scrap pipes, lumber, long handle tools, or other elongate objects. The system may comprise a pole that is telescopic, sectionally collapsible, or single piece.

The system may include sound-activated leveling-instrument. The system may accommodate ‘integrated mount’ or ‘add-on mount’ for commercially available level-instruments. The system may be functional using laser or optical level technology. The system may be rotated about the post to align with preferred measurement system. The system may feature motion value indicator to measure distance changes along longitudinal axis.

In accordance with the present invention, at least one possible configuration of the system can be advantageously manufactured at a comparatively low cost. Also, the system may provide for interchanging existing components to meet consumer budget/demands (such as, for instance, using scrap pipe with integrated-mount/leveling-instrument, or using commercially available leveling-instruments with a generic threaded mount system). Advantageously, the system does not require typical eight-foot (8′) pole lengths and/or an expanding design to accommodate interior static setup as can be required, in contrast, in connection with several conventional approaches for estimating grade variations. Also, the system does not require a calibrated target as can be required, in contrast, in connection with traditional tripod/survey methods.

In contrast to tripods, floor-to-ceiling poles, and other level mounting combinations/equipment that are static in nature, generally requiring an initial setup with limited mobility thereafter, and other approaches that require careful evaluation for present or future activity so as not to interfere with on-site activity, the system of the present invention can be configured to be setup instantly anywhere. Also, while other methods require multiple steps to relocate the associated equipment, the system of the present invention can be configured to be instantly relocated anywhere. Moreover, while other approaches may be limited by terrain and/or limited by lower/upper support opportunities, the system of the present invention can, in some configurations, be configured so as not to be limited by terrain beyond a single point ground support, and may be used in any location inside or outside of a structure.

While tripods, floor-to-ceiling poles, and other level mounting combinations or equipment may be complex to setup, the system of the present invention can be configured to minimize such complexity via, for example, configuring the system to be operable without limitations imposed by the location of use, ensuring that no procedural leveling tasks such as turning knobs are necessary, and minimizing or eliminating extra steps to establish post rigidity. The level of expertise necessary to operate the system is greatly reduced compared to traditional, complicated leveling instruments with multiple components that must be considered independently and function harmoniously.

The system may incorporate a motion value indicator to automatically measure distance changes along longitudinal axis for immediate results, and dynamic feedback as position(s) are changed. Also, at least one configuration of the system is completely functional with single handed operation; longitudinally, laterally, and for complete/instant relocation.

Typical set up tasks involved with tripods, floor-to-ceiling poles, and other level mounting combinations/equipment can include an initial setup for the support and/or mounting of the equipment, followed by setup of the leveling-instrument at each new position/location. In contrast, the system of the present invention provides, in one configuration, a simple hand-to-pole fulcrum alignment technique using limited pole motion (from ground pivot point) to advantageously properly orient a leveling-instrument. The system can also offer rotational freedom to align with various pole marks that define different measuring units.

The inspections performed by supervisors, homeowners, designers, engineers, and other parties may interfere with job-site resources such as personnel and/or equipment. Moreover, upon the arrival of these parties conducting such inspections, ongoing work must be delayed or is otherwise interrupted as survey equipment is commandeered. One configuration of the system of the present invention offers a new combination of speed, accuracy, and mobility to establish and/or verify construction elevations while minimizing the impact on job-site operations. This system may also be used in concert with more permanent instruments to determine ideal locations for complex setups.

### BRIEF DESCRIPTION OF THE DRAWINGS

FIG. 1 is a side elevational schematic view of the core system of the present invention;

FIG. 2 is a side elevational schematic view of the core system;

FIG. 3 is a front elevational view of the pole;

FIG. 4 is a perspective view of features of the pole shown in FIG. 3;

FIG. 5 is also a perspective view of features of the pole shown in FIG. 3;

FIG. 6 is a perspective view of features of the pole shown in FIG. 3;

FIG. 7 is a perspective view of this other configuration of the core system;

FIG. 8 is a perspective view of this other configuration of the core system;

FIG. 9 is a side elevational schematic view of the core system of the present invention;

FIG. 10 is a side elevational schematic view of the core system;

FIG. 11 is a top perspective view of a scenario in which an operator operates the core system to provide information concerning a profile characteristic of a surface; and

FIG. 12 is an enlarged perspective view of the grip combine.

### DETAILED DESCRIPTION OF AN EMBODIMENT

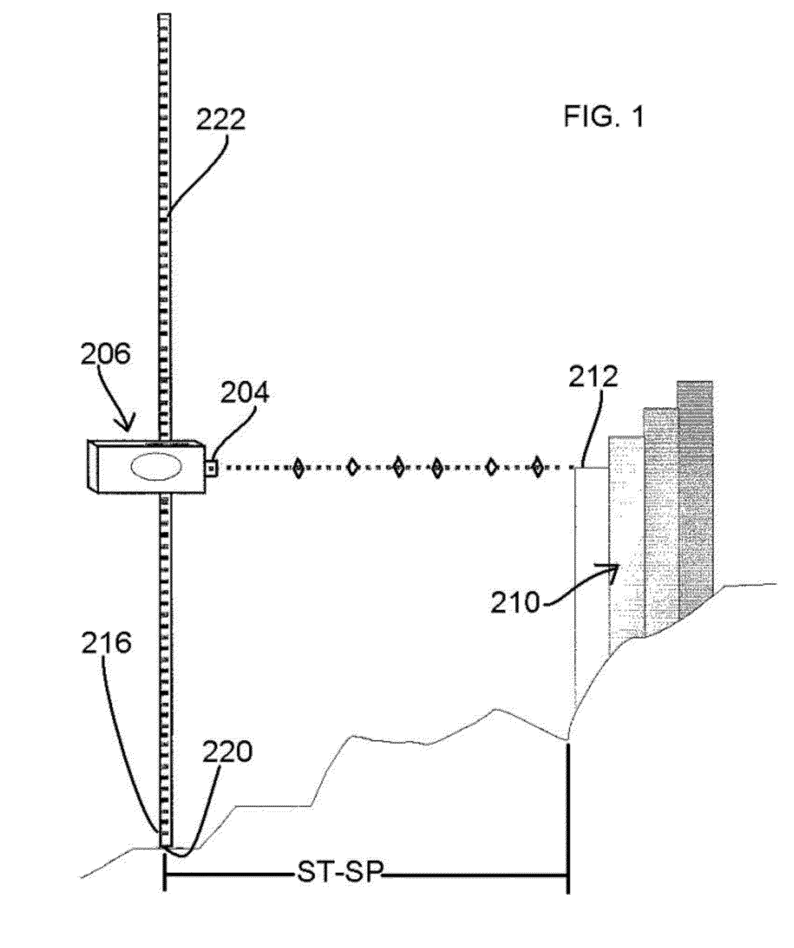

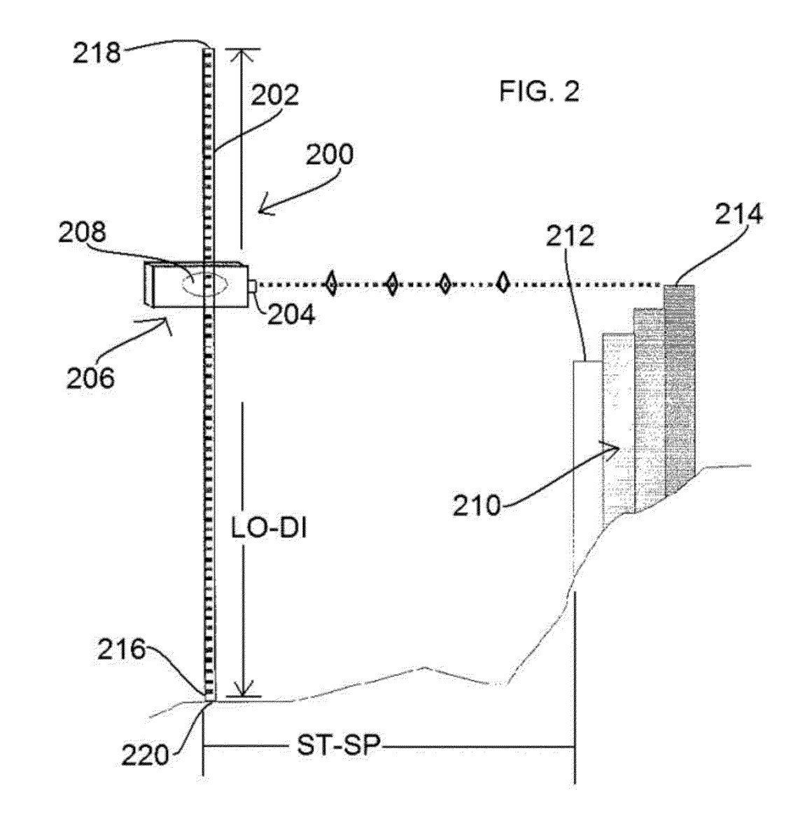

The present invention provides a system that provides information to assess a profile characteristic of a surface. Particular details of a kit version of the system of the present invention will be provided herein but, initially, an overview of the inventive system will be provided with reference to FIGS. 1 and 2, wherein a core system is illustrated. As seen in FIG. 1, which is a side elevational schematic view of the core system of the present invention, the core system, hereinafter designated as the core system 200, comprises a reference component in the form of a pole 202, a first target kickoff device in the form of a scope 204, a follow-on positioner in the form of a movable bracket 206, a data interplay device in the form of a chip 208, and other components that will be described hereinafter. The core system 200 is operable to provide information to assess a profile characteristic of a surface such as, as exemplarily illustrated in FIG. 1, a surface formed by a plurality of steps forming the front steps 210 of a residential house (not shown) and, for exemplary illustration purposes, the following description of the core system 200 will describe an operation of the core system for assessing a profile characteristic of the front steps 210 in the nature of a profile characteristic specifying the difference in elevation between a bottom step 212 and a top step 214 of the front steps 210.

The pole 202 has a fulcrum end 216 and a remote end 218, the fulcrum end 216 and the remote end 218 delimiting therebetween a longitudinal dimension LO-DI of the pole 200. The fulcrum end 216 of the pole 202 is removably positionable on a stand-off site 220 which, in the illustration shown, is a ground location in the front yard of the residential house having the front steps 210 and this stand-off site 220 is at a lateral spacing from the front edge of the front steps 210, this lateral spacing being designated as the stand-off spacing ST-SP.

The scope 204 is mountable to the pole 202 at a base reading spot on the pole 202 and the scope 204 is operable to emit an incident signal to the incident on an initial target on a surface that is spaced from the stand-off site 220 with the incident signal being detectable such that an operator can determine that an incident signal emitted by the scope 204 has been incident on the initial target. Merely for illustration purposes, the pole 202 is subdivided longitudinally into a series of uniformly spaced tick marks 222 with each tick mark representing a one inch increment. The initial target is the bottom step 212 of the front steps 210 of the residential house (not shown). The base reading spot of the scope 204 shown in FIG. 1 is, for example, a reading of 24 inches as measured from the scope 204 to the fulcrum end 216 of the pole 202.

As seen in FIG. 2, which is a side elevational schematic view of the core system, the core system is now operated, in a manner described shortly below, to provide additional information following the information provided with respect to the base reading spot. The core system 200 also includes, as noted, the movable bracket 206 and this movable bracket is operable, while the fulcrum end 216 of the pole 202 is positioned on the stand-off site 220, to dispose a target pickoff device at a follow-on reading spot relative to the pole 202 that is longitudinally spaced from the base reading spot. The movable bracket 206 is operable to dispose at least one of the scope 204 or another target pickoff device at the follow on reading location so that the respective target pickoff device can emit an incident signal to the incident on at least a selected one of the initial target or a subsequent target on the surface that is spaced from the stand-off site 220—namely, the surface of the front steps 210. Merely for illustration purposes, the movable bracket 206 is shown as disposing the scope 204 at the follow on reading location such that the scope 204 can emit an incident signal. In this connection, the incident signal emitted by the scope 204 at the follow-on reading spot is selected to be a target different than the initial target of the bottom step 212 of the front steps 210; the subsequent target in this example is the top step 214 of the front steps 210.

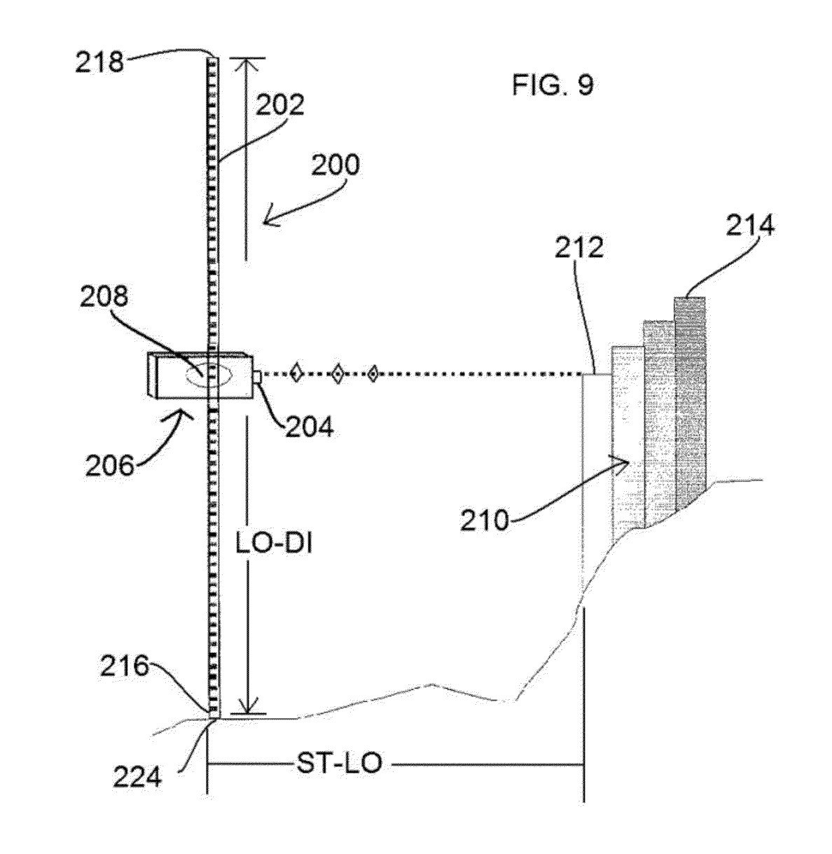

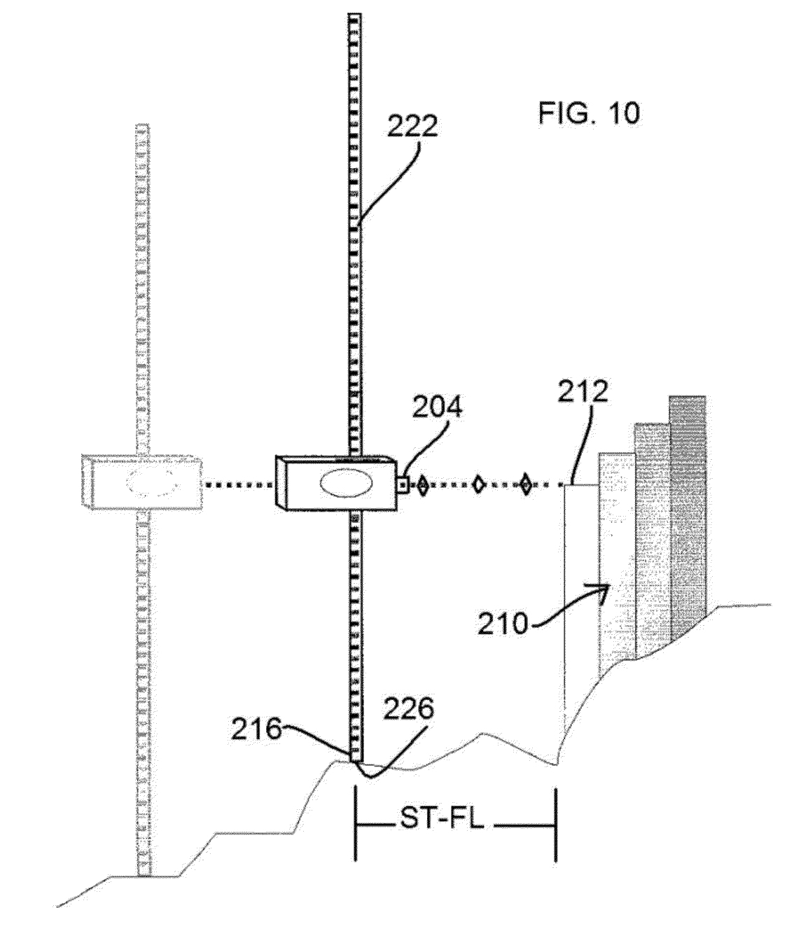

The chip 208 offers longitudinal data relating to the base reading spot and the follow-on reading spot. In the event, for example, the follow-on reading spot at which the scope 204 is supported by the movable bracket 206 to permit the scope to emit an incident signal onto the subsequent target of the top step 214 is at a longitudinal spacing of 32 inches from the fulcrum end 216 of the pole 202, the chip 208 offers the longitudinal data relating to the base reading spot of 24 inches from the fulcrum end 216 of the pole and the follow-on reading spot of 32 inches from the fulcrum end 216 of the pole. An operator can thus assess that the difference in elevation between the bottom step 212 of the front steps 210 and the top step 214 of the front steps is equal to the difference in value between the follow-on reading spot of 32 inches and the base reading spot of 24 inches—namely, an eight inch difference in elevation [72 inches−24 inches=8 inches]. The operator thereby determines that the difference in elevation between the bottom step 212 of the front steps 210 and the top step 214 of the front steps 210 is 48 inches. This method of operation of the core system 200 is referred to as the “relative” method. An alternative method of operation of the core system 200, referred to as the “benchmark” method will be described hereinafter in connection with FIGS. 9 and 10; however, the next following description provides more information concerning the details of the components of the core system 200.

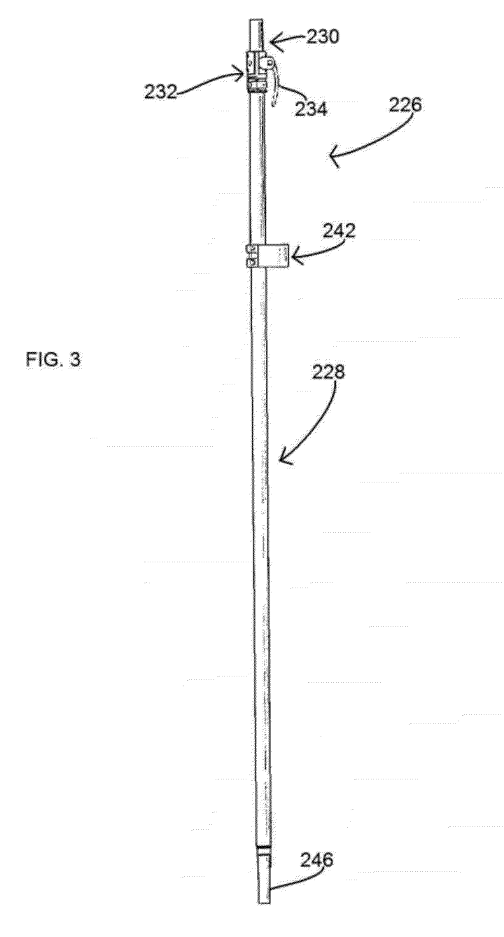

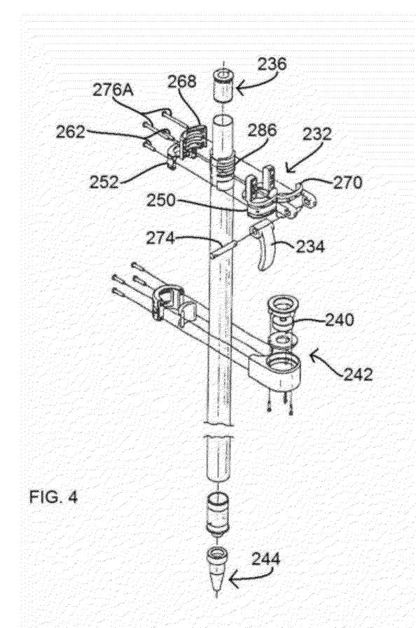

With reference now to FIG. 3, which is a front elevational view of the pole, and FIGS. 4-6, each of which is a perspective view of features of the pole shown in FIG. 3, the pole 202 includes a first pole section 228 and a second pole section 230 telescopingly received in the first pole section and these pole sections can be made out of a lightweight, non-metallic composite material such as fiberglass. However, it is to be understood that the pole sections could be made of a lightweight (typically lower strength) metal or other composite material without departing from the scope of the present invention. As seen in FIGS. 3 and 4, the second pole section 230 is retracted almost fully within the first pole section 228. A locking mechanism 232 is attached to the first pole section 228 and is capable of releasably clamping the second pole section 230 in a fixed position of extension relative to the first pole section by moving a lever 234 of the locking mechanism.

An end fitting 236 is located at the top of the second pole section 230 and forms the remote end 218 of the pole 202. A level gauge indicating device 240 is supported on a level gauge holder 242 and affixed to the first pole section 228 and this level gauge indicating device 240 may be, for example, a bubble level wherein a bubble movably supported in a liquid chamber can be visually observed to determine when the bubble is centered between a pair of indicator markings, thereby indicating that a given alignment with a horizontal or vertical reference has been achieved. The lower end of the pole 202 has, as shown in FIG. 4, a metal point 244 screwed into the first pole section 228 for engaging the ground and this metal point forms the fulcrum end 216 of the pole 202. The metal point 244 can be covered by a cover 246, as shown in FIG. 3.

The locking mechanism 232 includes a base 248 comprising a first base member 250 and a second base member 252 that may be formed of a substantially rigid plastic. The first base member 250 is sized and shaped to fit over the top end of the first pole section 228 such that a collar 254 rests generally on the top end of the first pole section and a depending, semi-cylindrical skirt 256 engages one side of the first pole section adjacent thereto. A central opening of the collar 254 is sized to permit the second pole section 230 to pass freely through the first base member 250. Metal thread elements 258 are force fitted into openings (not shown) in the skirt 256. The semi-cylindrical second base member 252 engages the opposite side of the first pole section 228 just below the top end and is attached to the skirt 256 of by bolts 262 which pass through the second base member and into the thread elements 258 in the skirt. Thus, the base 248 is held on the top end of the first pole section 228 by engagement of the collar 254 with the end of the first pole section and by the clamping action of the opposed skirt 256 and second base member 252 through their interconnection by the bolts 262.

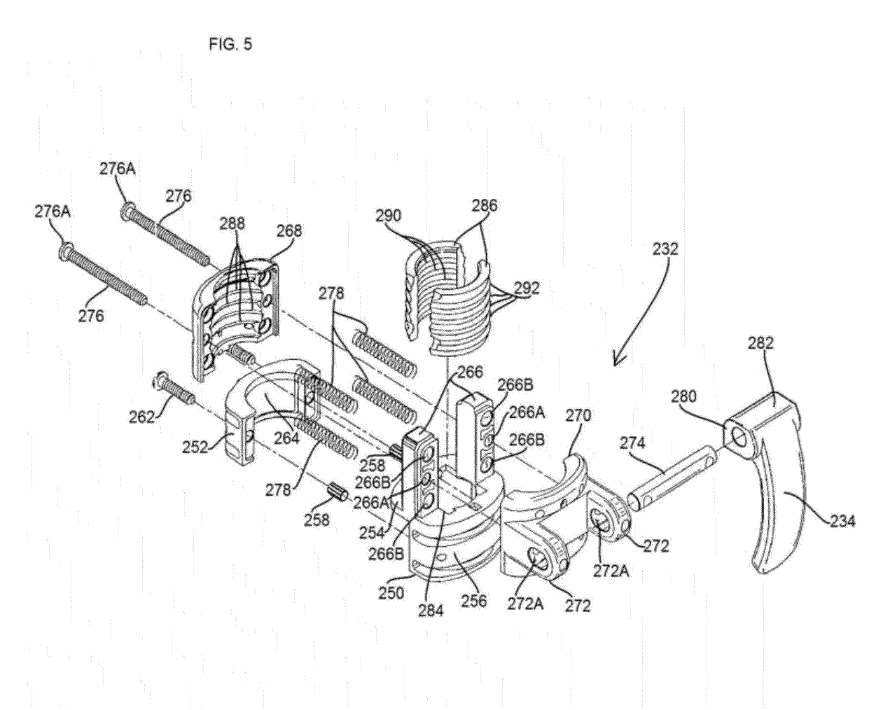

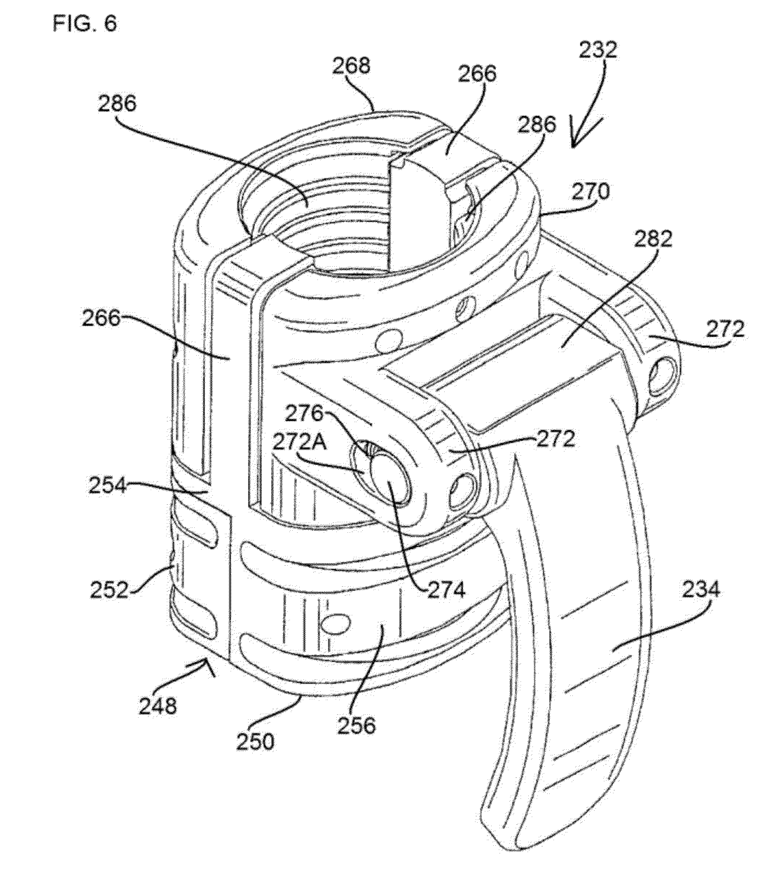

As seen in FIGS. 5 and 6, the first base member 250 further includes a pair of diametrically opposite supports 266 projecting axially upward from the collar 254 of the first base member for supporting an upper clamping assembly operable to clamp the second pole section 230 in a fixed position of extension relative to the first pole section 228. The upper clamping assembly comprises a front clamping jaw 268 and a rear clamping jaw 270 formed of the same rigid plastic as the first and second base members 250, 252. The rear clamping jaw 270 is generally semi-cylindrical in shape and includes a pair of spaced apart ears 272 projecting outward from the rear clamping jaw. The ears 272 are each formed with an elongated opening 272A which receives a pivot pin 274 mounting the lever 234 on the rear clamping jaw 270. The front clamping jaw 268 is attached to the rear clamping jaw 270 by a pair of bolts 276 which pass through the front clamping jaw and respective middle openings 266A in the supports 266 of the base 248 and into the rear clamping jaw. The bolts 276 each pass through the semi-cylindrical portion of the rear clamping jaw 270 and into a respective one of the elongate openings 272A in the ears 272. Four coil springs 278, each extending through a respective spring hole 266B in the supports 266 of the base 248, are interposed between the front and rear clamping jaws 268, 270, biasing the jaws apart from each other and away from the second pole section 230 to an unlocked position.

Actuation of the locking mechanism 232 to move the front and rear clamping jaws 268, 270 between the locked and unlocked positions is accomplished by the lever 234, mounted for pivoting about a horizontal axis by the pivot pin 274. The ends of the pivot pin are received in the elongate openings 272A of the ears 272 of the rear clamping jaw 270, and are capable of relative movement lengthwise of the elongate openings. The bolts 276 interconnecting the front and rear clamping jaws 268, 270 pass through and are threadably engaged with the pivot pin 274 within the elongate openings2 72A of the ears. The threaded engagement of the bolts 276 in the pivot pin 274 fixes the distance between heads 276A of the bolts and the pivot pin, and consequently the distance between the axis of rotation of the lever 234 and the bolt heads. Camming action of the lever 234 produces movement of the front and rear clamping jaws 268, 270 between the locked and unlocked positions. The lever 234 includes an attachment end having a passage through which the pivot pin 274 is received. The attachment end is asymmetrical with respect to the passage, having a greater thickness of material (relative to the passage) on a rounded locking surface 280 than on a flat unlocking surface 282. In the unlocked position, the lever 234 extends laterally outward from the locking mechanism 232 and the flat unlocking surface 282 engages the rear clamping jaw 270, allowing the maximum space between the heads 276A of the bolts and the pivot pin 274. Thus, the front and rear clamping jaws 268, 270 are able to move under the bias of the coil springs 278 away from each other and out of engagement with the second pole section 230. When the lever 234 is pivoted down on the pivot pin 274, the rounded locking surface 282 engages the rear clamping jaw 270, simultaneously pushing the rear clamping jaw forward and pulling (by operation of the bolt heads 276A) the front clamping jaw 268 rearward to clamp against the second pole section 230.

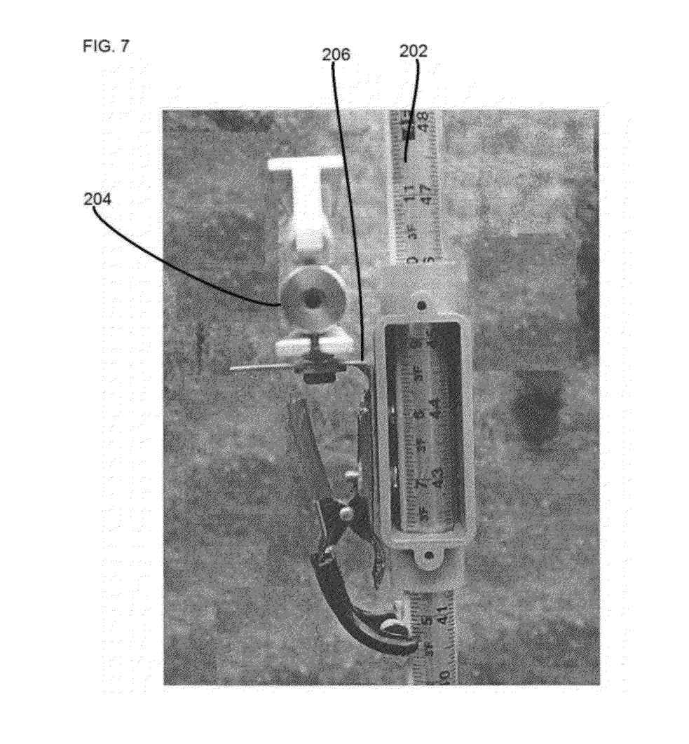

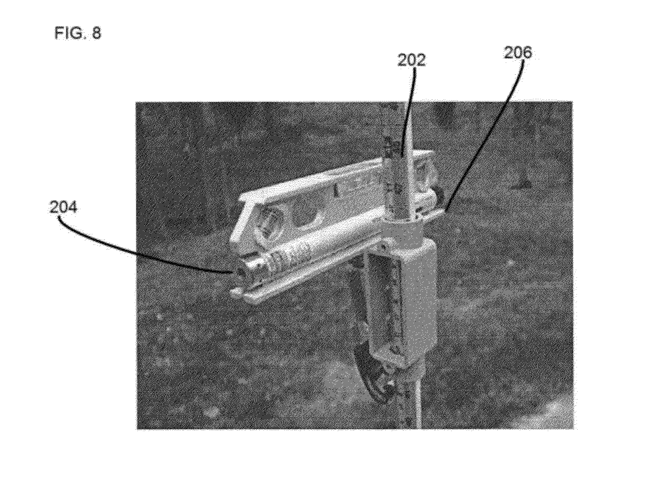

Reference is now had to FIGS. 7 and 8 in connection with a description of another configuration of the core system 200. As seen in FIG. 7, which is a perspective view of this other configuration of the core system 200, the movable bracket 206 is operable to be releasably secured to the pole 202 and the movable bracket 206 supports the scope 204 at a perpendicular orientation relative to the pole 202. The movable bracket 206 includes a spring biased hand grip that releases and engages a gripping head in contact with the pole 202. This movable bracket 206 is operable, while the fulcrum end 216 of the pole 202 is positioned on the stand-off site 220, to dispose a target pickoff device at a follow-on reading spot relative to the pole 202 that is longitudinally spaced from the base reading spot. As seen in FIG. 8, which is a perspective view of this other configuration of the core system 200, the movable bracket 206 also supports, on the top of the scope 204, a level gauge indicating device that is a bubble level wherein a bubble movably supported in a liquid chamber can be visually observed to determine when the bubble is centered between a pair of indicator markings, thereby indicating that the pole 202 is in a vertical position.

Reference is now had to FIGS. 9 and 10 in connection with a description of an alternative method of operation of the core system 200, referred to as the “benchmark” method. As seen in FIG. 9, which is a side elevational schematic view of the core system of the present invention, the core system is operable to provide information to assess a profile characteristic of a surface such as, as exemplarily illustrated in FIG. 9, a ground surface formed by a lower area or swale. For exemplary illustration purposes, the following description of the core system 200 will describe an operation of the core system for assessing a profile characteristic of the swale 224 and the operation involves a deployment of the core system 200 to determine specific information relating to the relationship of the core system 200 and the front steps 210 of a residential house (not shown) having the bottom step 212 and the top step 214.

The fulcrum end 216 of the pole 202 is removably positionable on the swale stand-off site 224 which, in the illustration shown, is a ground location in the front yard of the residential house at a relatively lower elevation than other portions of the front yard and this swale stand-off site 224 is at a lateral spacing from the front edge of the front steps 210, this lateral spacing being designated as the swale stand-off spacing ST-LO.

The scope 204 is mountable to the pole 202 at a base reading spot on the pole 202 and the scope 204 is operable to emit an incident signal to the incident on an initial target on a surface that is spaced from the swale stand-off site 224 with the incident signal being detectable such that an operator can determine that an incident signal emitted by the scope 204 has been incident on the initial target. Merely for illustration purposes, the pole 202 is subdivided longitudinally into a series of uniformly spaced tick marks 222 with each tick mark representing a one inch increment. The initial target is the bottom step 212 of the front steps 210 of the residential house (not shown). The base reading spot of the scope 204 shown in FIG. 9 is, for example, a reading of 24 inches as measured from the scope 204 to the fulcrum end 216 of the pole 202.

As seen in FIG. 10, which is a side elevational schematic view of the core system, the core system is operable, in a manner described shortly below, to provide more information in addition to the information provided with respect to the base reading spot. In connection with obtaining this additional information, the next step of the “benchmark” method of operation of the core system 200 involves: (a) moving the pole 202 to a new location spaced from the swale stand-off site 224 and placing the fulcrum end 216 of the pole onto this new location, (b) with the fulcrum end 216 of the pole placed onto this new location, moving the scope 204 and the pole 202 relative to one another so that the scope 204 can emit an incident signal that will be incident upon the same initial target (the bottom step 212 of the front steps 210 of the residential house (not shown)), and (c) gathering information from the target pickoff device—the scope 204—that is representative of the longitudinal spacing of the follow-on reading spot relative to the base reading spot. Thus, the pole 202 is now moved to a new location spaced from the swale stand-off site 224—this new location hereinafter being designated as the flat ground stand-off site 226—and the fulcrum end 216 of the pole is placed onto this new location. The flat ground stand-off site 226 is at a spacing ST-FL from the bottom step 212 of the front steps 210 and this spacing may be the same or different than the spacing ST-LO of the swale stand-off site 224. The movable bracket 206 is then operable, while the fulcrum end 216 of the pole 202 is positioned on the swale stand-off site 224, to dispose the scope 204 at a follow-on reading spot relative to the pole 202. The movable bracket 206 is operable to dispose at least one of the scope 204 or another target pickoff device at the follow on reading location so that the respective target pickoff device can emit an incident signal to the incident on at least a selected one of the initial target or a subsequent target on the surface that is spaced from the swale stand-off site 224. In connection with this “benchmark” method of operation of the core system 200, the respective target pickoff device is positioned at a follow-on reading spot relative to the pole 202 that is longitudinally spaced from the base reading spot such that the scope 204 again emits an incident signal that is incident on the initial target—namely, the initial target that was selected as the bottom step 212 of the front steps 210 of the residential house (not shown). Merely for illustration purposes, the movable bracket 206 is shown as disposing the scope 204 at the follow on reading location such that the scope 204 can emit an incident signal.

The chip 208 offers longitudinal data relating to the base reading spot and the follow-on reading spot. In the event, for example, the follow-on reading spot at which the scope 204 is supported by the movable bracket 206 to permit the scope to emit an incident signal onto the subsequent target of the top step 214 is at a longitudinal spacing of 37 inches from the fulcrum end 216 of the pole 202, the chip 208 offers the longitudinal data relating to the base reading spot of 24 inches from the fulcrum end 216 of the pole and the follow-on reading spot of 37 inches from the fulcrum end 216 of the pole. An operator can thus assess that the difference in elevation between the swale and the flat ground locations is equal to the difference in value between the follow-on reading spot of 35 inches and the base reading spot of 24 inches—namely, a fifteen (15) inch difference in elevation [37 inches−24 inches=15 inches]. The operator thereby determines that the difference in elevation between the swale and the flat ground location is 15 inches.

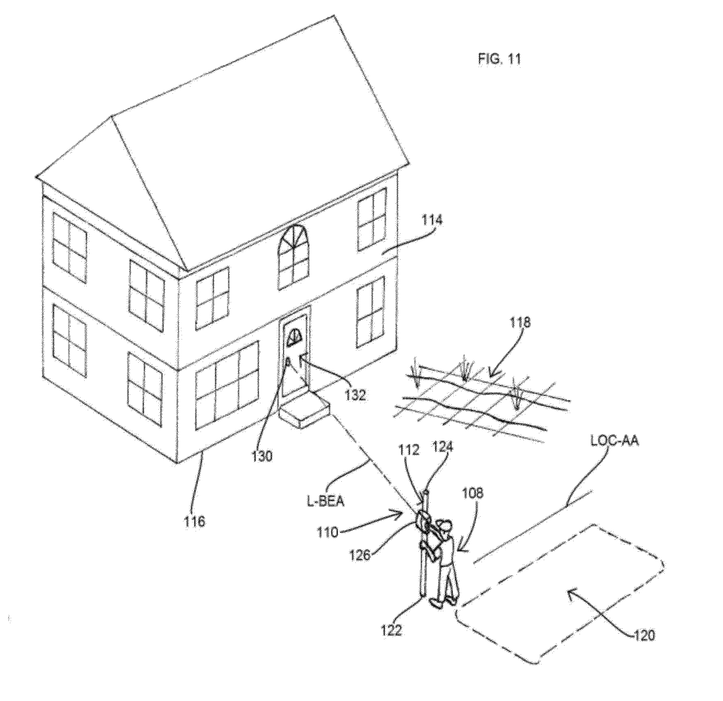

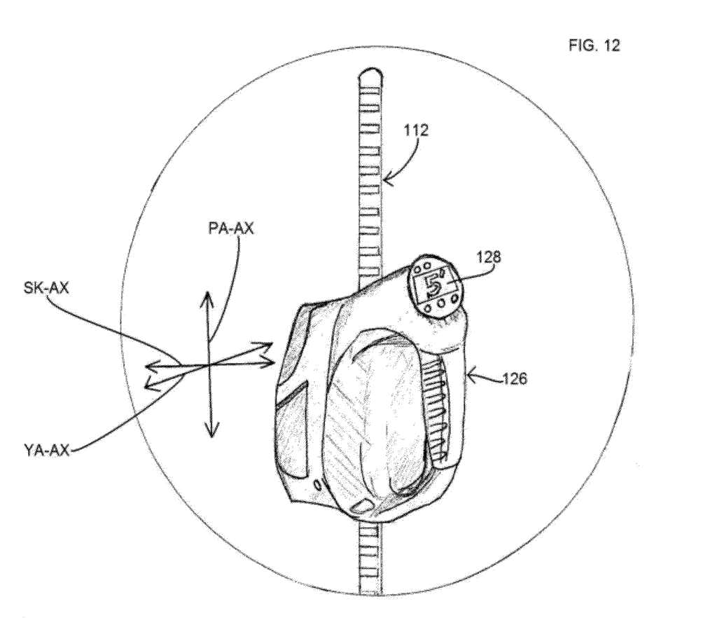

Reference is now had to FIGS. 11 and 12 for details concerning another deployment scenario involving the core system 200. As shown in FIG. 11, which is a top perspective view of a scenario in which an operator operates the core system to provide information concerning a profile characteristic of a surface, the configuration of the core system 200 illustrated in FIGS. 11-12 is in the form of a kit 110 that enables the operator 108 to deploy the core system 200 without assistance from another person and to easily and rapidly change locations and set up the core system to perform its tasks. For exemplary illustration purposes, the operator 108 is shown as operating the kit 110 to provide information—such as elevation information—concerning a profile characteristic of a surface, which could be a swale or relatively low elevation area and this swale is designated as a location LOC-AA in the front yard of a residential house 114 at a spacing of several feet from a bottom longitudinal edge 116 of a front side of the residential house 114 that is in contact with a ground surface 118 on which the house 114 stands. The location LOC-AA is a location at which a landscape feature 120 (shown in broken lines), which may be, for example, a flowerbed having a collection of flowers, is to be configured. The operator 108 in this exemplary deployment scenario deploys the kit 110 with the goal of assessing a profile characteristic of the ground surface 118—specifically, the difference or variation in grade between the bottom longitudinal edge 116 of the rear side of the residential house 114 and the location LOC-AA—to ensure that water drainage or run-off from the landscape feature 120 does not create a problem at the house 114.

The operator 108 operates the kit 110 to obtain this elevation information with respect to location LOC-AA and operates the kit 110 in accordance with the “relative” method or the “benchmark” method previously described. The operator 108 stands upright at the location LOC-AA and faces the front side of the house 114. The operator 108 places the pole 112 of the kit 110 in an intermediate position in which the pole 112 is between or intermediate the operator 108 and the front side of the house 114 with a lower end 122 of the pole in contact with the ground surface 118. The operator uses one hand to engage the pole 112 at a location on the pole 112 at a spacing from the ground surface 118 between the lower end 122 and an upper end 124 of the pole and the operator maintains this one hand in engagement with the pole 112 and moves this one hand while engaged with the pole in a pole uprighting step in which the operator attempts to bring the pole into a dead vertical position while maintaining the lower end 122 of the pole in contact with the ground surface 118.

After the operator has substantially brought the pole 112 into a dead vertical position, the operator then, with the other hand, operates a data interface device in the form of a grip combine 126 having a number of features including an operator hand grip for engaging the grip combine to move it relatively along the pole 112, a trigger grip release assembly for actuation by the operator to selectively cause the grip combine 126 to remain at a selected location on the pole 112 and to selectively release the grip combine for relative movement along the pole, a laser scope for emitting an incident signal, an ASIC semiconductor chip for sensing and recording various data and for controlling a display 128 on the grip combine. The operator 112 grips the grip combine 126 and moves it vertically relative to the pole to a selected vertical position on the pole at which the grip combine 126 is releasably secured to the pole. During this movement of the grip combine 126 relative to the pole 112, the operator 108 maintains the pole 112 in its dead vertical position or restores the pole 112 to the dead vertical position once the grip combine 126 has been releasably secured to the pole at the selected vertical position.

The operator 108 then operates the laser scope of the grip combine 126 to project a light beam L-BEA onto a selected target on the front side of the house 114—specifically, a door handle 130 of a front door 132. In this exemplary deployment scenario, for example, the operator 108 has knowledge that the door handle 130 of the door 132 is at a vertical spacing of three feet or thirty six (36) inches above the bottom longitudinal edge 116 of the front side of the residential house 114.

As shown in FIG. 12, which is an enlarged perspective view of the grip combine, the grip combine 126 and the pole 112 are shown, and the pole has been brought into a dead vertical position by the operator 108. The pole 112 allows the grip combine 126 to be positioned on the pole at an appropriate height towards the upper end 124 of the pole or the grip combine 126 may be repositioned vertically towards the lower end 122 of the pole which is in contact with the ground 118. Then, once the grip combine 126 has been positioned at the base reading spot, the operator 108 presses a button, whereupon the grip combine 126 emits the light beam L-BEA horizontally across the yard to illuminate the door handle 130 of the door 132, and the operator 108 views the display 128 of the grip combine 126 which shows a digital reading (shown as the numeral “5”) of the base reading spot. The operator 108 may record this base reading spot information while remaining next to the pole 112. The operator 108 can thereafter move the pole 112 to another stand-off site, or maintain the pole 112 at the initial stand-off site, and obtain and record information concerning a follow-on reading spot. Additionally or alternatively, the grip combine 126 may record itself the base reading spot and follow-on reading spot information.

The laser scope of the grip combine 126 can be incorporated into any suitable assembly that reliably supports the scope for movement between the base reading spot and the follow-on reading spot. In addition, the laser scope of the grip combine 126 can be integrated into any suitable data capture/data recording/data transmitting arrangement having automatic or semi-automatic features. Thus, an arrangement can be provided that is highly automated and includes, in lieu of a level bubble, a gyroscopic feature that senses and displays and/or records position data of the laser scope of the grip combine 126 relative to three axes mutually perpendicular to one another shown in FIG. 12: a pitch axis PI-AX, a yaw axis YA-AX, and a skew axis SK-AX. This gyroscopic feature could thereby enable a determination to be made that the pole 112 on which the laser scope of the grip combine 126 is supported is oriented at exactly ninety-degrees relative to the target at which the incident signal will be emitted. Moreover, the degree of automation of a highly automated arrangement can be such that a single actuation by an operator—such as depressing a button on the grip combine 126—initiates an automatic sequence in which the laser scope of the grip combine 126 is controlled to emit a series of incident signals in the form of laser beam pulses in coordination with specific pre-programmed iterative movements of the laser scope of the grip combine 126 about the pitch, yaw, and skew axes and including capture of the positional data of the pole 112 at each iterative movement. Such an operation could permit an operator to gather a series of potential base location readings and/or follow on location readings that could then be culled to yield an optimally accurate reading. This could compensate for any operator-induced misalignment cause, for example, by supporting the pole 112 at an orientation that is not exactly ninety-degrees (perpendicular) to the target at which the incident signal will be emitted. Other enhancements could include: configuring the pole 112 as a collapsible sectioned mounting post adapted to be positioned in bearing engagement between a ground or floor surface and the control of an operator; configuring the grip combine 126 with a locking device to hold the grip combine in place while allowing lateral rotation of the entire the grip combine for multiple elevation checkpoints from a single location, and/or instant relocation of the grip combine to compare differences in reference point changes from the original location, or configuring the grip combine to be swung to upper and lower positions on the pole 112. Also, a support stand for supporting the pole 112 in an upright position can be provided and this support stand can optionally be deployable being a use configuration and a more compact collapsed configuration. Additionally, a carrying case can be provided for secure stowage and transport of the core system 200 in its various configurations.

The convenience of the kit 110 advantageously offers a high degree of convenience to an operator both in the ease of use of the kit, such as the rapid deployability of the kit in the field, and in the modest dimensions of the kit that avoid the need for substantial storage space. Beyond the ease of use provided by the rapid deployment capability, the kit offers ease of use in connection with the measurement or grade assessment process. For example, once the kit 110 is unpacked from its storage configuration and assembled for in-field use—i.e., the grip combine 126 has been assembled onto the pole 112—the kit 110 then permits the operator to single handedly perform all of the steps needed to obtain the measurement readings. The operator can selectively release the grip combine 126 from a given vertical position on the pole 112, re-position the grip combine 126 on the pole at an appropriate height, and, then, once the grip combine 126 has been positioned at the selected reading spot, the operator 108 can presses a button to cause emission of the light beam L-BEA so that the light beam is incident upon the selected pick-off target. As can be understood, all of these actions can be accomplished single handedly by the operator 108 in that, for example, the operator can uses a single hand to grip the grip combine 126, to move the grip combine 126 relatively up and down along the pole 112, and to press the button causing the light beam L-BEA to be emitted. The operator can also use his or her other hand to record any measurement readings on, for example, a paper on a clipboard or on an electronic recording device such as a tablet computer screen or a mobile telephone screen. The same single hand operation can be continued to obtain and record information concerning a follow-on reading spot.

The teachings of this application are not to be construed as being limited to any particular system or method. While various embodiments of the invention have been described and illustrated herein, it is to be distinctly understood that the invention is not limited thereto, but may be otherwise variously embodied and practiced within the scope of the following claims.

What is claimed is:

1. A system for providing information to assess a profile characteristic of a surface, the system comprising:
a reference component, the reference component having a fulcrum end and a remote end, the fulcrum end and the remote end of the reference component delimiting therebetween a longitudinal dimension of the reference component and the fulcrum end being removably positionable on a stand-off site;
a first target pick off device, the first target pick off device being mountable to the reference component at a base reading spot and being operable to emit an incident signal to be incident on an initial target on a surface that is spaced from the stand-off site with the incident signal being detectable such that an operator can determine that an incident signal emitted by the first target pick off device has been incident on the initial target;
a follow-on positioner, the follow-on positioner being operable, while the fulcrum end of the reference component is positioned on the stand-off site, to dispose a target pick off device at a follow-on reading spot relative to the reference component that is longitudinally spaced from the base reading spot, the follow-on positioner being operable to dispose at least one of the first target pick off device or another target pick off device at the follow-on reading spot at which the respective target pick off device can emit an incident signal to be incident on at least one of the initial target or a subsequent target on the surface that is spaced from the stand-off site; and
a data interplay device, the data interplay device offering longitudinal data relating to the base reading spot and the follow-on reading spot, wherein the system is operable to provide an operator with information relating to at least two longitudinal spaced locations of the reference component for use in assessing a profile characteristic of the surface.

2. The system according to claim 2, wherein the reference component is a pole.

3. The system according to claim 3, wherein the first target pickoff device is a laser beam emitting device.

4. The system according to claim 3, wherein the follow-on positioner is releasably securable at selected positions on the pole.

5. The system according to claim 4 and further comprising a level gauge indicating device, the level gauge indicating device being operable to indicate a degree of deviation of the pole from a selected orientation.

6. The system according to claim 1 and further comprising a motion value indicator operable to provide measurement information with respect to a change of distance along an axis perpendicular to the longitudinal dimension of the reference component.

7. A system for providing information to assess a profile characteristic of a surface, the system comprising:
a reference component, the reference component having a fulcrum end and a remote end, the fulcrum end and the remote end of the reference component delimiting therebetween a longitudinal dimension of the reference component and the fulcrum end being removably positionable on a first stand-off site and a second stand-off site at a spacing from the first stand-off site;
a first target pick off device, the first target pick off device being mountable to the reference component at a base reading spot and being operable, while the fulcrum end of the reference component is positioned on the first stand-off site, to emit an incident signal to be incident on an initial target on a surface that is laterally spaced from the first stand-off site with the incident signal being detectable such that an operator can determine that an incident signal emitted by the first target pick off device has been incident on the initial target;
a follow-on positioner, the follow-on positioner being operable, while the fulcrum end of the reference component is positioned on the second stand-off site, to dispose a target pick off device at a follow-on reading spot relative to the reference component that is longitudinally spaced from the base reading spot, the follow-on positioner being operable to dispose at least one of the first target pick off device or another target pick off device at the follow-on reading spot at which the respective target pick off device can emit an incident signal to be incident on at least one of the initial target or a subsequent target on the surface that is laterally spaced from both the first stand-off site and the second stand-off site; and
a data interplay device, the data interplay device offering longitudinal data relating to the base reading spot and the follow-on reading spot, wherein the system is operable to provide an operator with information relating to at least two longitudinal spaced locations of the reference component for use in assessing a profile characteristic of the surface.

8. The system according to claim 7, wherein the reference component is a pole.

9. The system according to claim 8, wherein the first target pickoff device is a laser beam emitting device.

10. The system according to claim 9, wherein the follow-on positioner is releasably securable at selected positions on the pole.

11. The system according to claim 10 and further comprising a level gauge indicating device, the level gauge indicating device being operable to indicate a degree of deviation of the pole from a selected orientation.

12. The system according to claim 7 and further comprising a motion value indicator operable to provide measurement information with respect to a change of distance along an axis perpendicular to the longitudinal dimension of the reference component.
